(19) United States
(12) Patent Application Publication
(10) Pub. No.: US 2024/0292839 A1
(43) Pub. Date: Sep. 5, 2024

(54) Insecticidal Composition Comprising of Diamide, Moulting Hormone Agonist and Pyrethroid

(71) Applicant: WILLOWOOD CHEMICALS LIMITED, New Delhi (IN)

(72) Inventors: Parikshit MUNDHRA, New Delhi (IN); Jitendra MOHAN, New Delhi (IN)

(21) Appl. No.: 18/278,536

(22) PCT Filed: Feb. 22, 2022
(86) PCT No.: PCT/IN2022/050154

§ 371 Date: Aug. 23, 2023

(30) Foreign Application Priority Data
Feb. 25, 2021 (IN) 202111008065

(51) Int. Cl. A01N 43/56; A01N 25/04; A01N 37/28; A01N 53/00; A01P 7/04

(52) U.S. Cl. CPC A01N 43/56; A01N 25/04; A01N 37/28; A01N 53/00; A01P 7/04

(57) ABSTRACT

The present provides a synergistic insecticidal composition comprising Chlorantraniliprole. Methoxy fenozide and at least one insecticidal compound selected from Deltamethrin or Lambda-Cyhalothrin. process of preparation of the composition and uses thereof.

### FIELD OF THE INVENTION

The present invention relates to a synergistic insecticidal composition comprising of class of diamide insecticide such as Chlorantraniliprole, diacylhydrazine class of insecticide/moulting hormone agonist such as Methoxyfenozide and at least one insecticidal compound selected from the class of pyrethroids such as Deltamethrin or Lambda-Cyhalothrin.

### BACKGROUND OF THE INVENTION

In economically important crops, higher crop efficiency is achieved by controlling the invertebrate pests. Invertebrate pest causes damage to growing and stored agronomic crops and thereby result in significant reduction in the crop productivity. Therefore, the control of invertebrate pests is economically important for the enhanced crop productivity. Many products are available as solo or in combinations of two or more active ingredients. However, more economically efficient and ecologically safe pesticidal composition and methods are still being sought.

In order to reduce the risk from increased number of resistant pest strains, mixtures of different active compounds are now a days employed for controlling harmful pests. By combining different active compounds having different mechanisms of action, it is possible to ensure effective control of pests of different groups over a relatively longer period of time and preventing development of resistance.

Therefore, there still exist a need in the art to develop insecticidal composition, which is stable, synergistic, broad spectrum, environmentally safe, more effective in control of a wide spectrum of insect pests in crops. The insecticidal compositions must show a broader scope of activity to avoid or to prevent the development of resistant varieties of strains to the active ingredients or to the mixtures of known active ingredients used by farmer while minimising the doses of chemicals sprayed in the agriculture fields.

As a solution to the above mentioned problems, the inventors of the present invention surprisingly found that composition comprising Chlorantraniliprole, Methoxyfenozide and at least one insecticidal compound selected from Deltamethrin or Lambda-Cyhalothrin provides effective control of a wide spectrum of insect pests.

### SUMMARY OF THE INVENTION

Accordingly, the present invention provides a synergistic insecticidal composition comprising: Chlorantraniliprole, Methoxyfenozide, at least one compound selected from Deltamethrin and Lambda-Cyhalothrin and one or more excipients.

In an embodiment, the synergistic insecticidal composition comprises Chlorantraniliprole in the range of 1 to 30% w/w, Methoxyfenozide in the range of 1 to 30% w/w, at least one compound selected from Deltamethrin and Lambda-Cyhalothrin in the range from 1 to 10% w/w; and one or more excipients.

In another embodiment, the present invention provides a synergistic composition comprising Chlorantraniliprole in an amount 6% w/w, Methoxyfenozide in an amount 21% w/w; Deltamethrin in an amount 1.25% w/w; and one or more excipients.

In yet another embodiment, the present invention provides a synergistic composition comprising Chlorantraniliprole in an amount 6% w/w, Methoxyfenozide in an amount 21% w/w, Lambda-Cyhalothrin in an amount of 1.5% w/w and one or more excipients.

In one another embodiment, the composition of the present invention is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or a mixed formulation of CS and SE (ZE), a mixed formulation of CS and EW (ZW). In yet another embodiment, the composition is preferably formulated as SC and ZC.

In an embodiment, the excipient used in the present invention is selected from the group comprising of surfactant/dispersing agent, wetting agent, emulsifier, anti-freeze agent, defoamer, biocide, thickener, solvent and capsule forming monomer I and II and other excipients as will be required in a particular type of formulation.

In another embodiment, the excipient is selected from the group comprising of dispersing agent present in an amount in the range from 2 to 10% w/w; wetting agent present in an amount in the range from 1 to 5% w/w; emulsifier present in an amount in the range from 2 to 5% w/w; anti-freeze agent present in an amount in the range from 2 to 10% w/w; defoamer present in an amount in the range from 0.01 to 0.5% w/w; biocide present in an amount in the range from 0.01 to 0.5% w/w; thickener present in an amount in the range from 0.01 to 0.5% w/w; solvent present in an amount in the range from 5 to 15% w/w and capsule forming monomer I and II present in an amount in the range from 0.2 to 3% w/w.

In another embodiment, the dispersing agent is selected from the group comprising of amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer, ethoxylated polyarylphenol phosphate ester or a combination thereof.

In one another embodiment, the wetting agent is selected from the group comprising of ethoxylated polyarylphenol phosphate ester, dioctyl sulphosuccinate, non-ionic ethoxylate or a combination thereof.

In yet another embodiment, the emulsifier is selected from the group comprising of tristyryl phenol, polyalkylene oxide block copolymer, high molecular weight polymer PEG-10 PPG-5 cetyl phosphate, ethylene oxide (EO)-polyethylene oxide (PO) block copolymer, non-ionic ethoxylated emulsifier, blend of nonionic-anionic emulsifiers (proprietary blend) or a combination thereof.

In an embodiment, anti-freeze agent is selected from the group comprising of propylene glycol, diethylene glycol, monoethylene glycol or a combination thereof.

In another embodiment, the defoamer is selected from the group comprising of dimethyl polysiloxane emulsion, polysiloxane emulsion or a combination thereof.

In one another embodiment, the biocide is selected from the group comprising of 20% aqueous dipropylene glycol solution of 1,2-benzisothiazolin-3-one, formaldehyde, isothiazolinone or a combination thereof. In yet another embodiment, the thickener is xanthan gum.

In one another embodiment, the solvent is selected from the group comprising of naphtha, butan-1-ol, xylene, decanamide, N-methyl-2-pyrrolidone, dimethyl sulfoxide, solvent C9, water or a combination thereof.

In one another embodiment, the capsule forming monomer I is selected from polyisocyanate, toluene di-isocyante and tri-isocyanate and is present in an amount in the range from 0.5 to 3% w/w.

In yet another embodiment, the capsule forming monomer II is selected from ethylenediamine, diethylenetetramine and hexaethylenediamine and is present in an amount in the range from 0.2 to 2% w/w.

### DETAILED DESCRIPTION OF THE INVENTION

The definitions provided herein below for the terminologies used in the present disclosure are for illustrative purpose only and in no manner limit the scope of the present invention disclosed in the present disclosure.

Unless defined otherwise, all technical and scientific terms used herein have the same meaning as commonly understood by one of ordinary skill in the art to which the invention pertains. Although other methods and materials similar, or equivalent, to those described herein can be used in the practice of the present invention, the preferred materials and methods are described herein.

As used herein, the term “composition” or “formulation” can be used interchangeably. The expression of various quantities in terms of “% w/w” or “%” means the percentage by weight, relative to the weight of the total solution or composition unless otherwise specified.

The term “active ingredient”, “(a.i.)” or “active agent” used herein refers to that component of the composition responsible for control of insect pests.

As used herein, the term “Chlorantraniliprole” encompasses its agrochemically acceptable salt(s), derivative(s) or any other modified form of Chlorantraniliprole. It belongs to the class of diamide insecticide. It acts by activation of ryanodine receptors, leading to loss of internal calcium stores.

As used herein, the term “Methoxyfenozide” encompasses its agrochemically acceptable salt(s), derivative(s) or any other modified form of Methoxyfenozide. It belongs to the class of diacylhydrazine insecticide. It acts by lethally accelerating the moulting process, it is primarily active by ingestion, also with some contact and ovicidal activity.

As used herein, the term “Deltamethrin” encompasses its agrochemically acceptable salt(s), derivative(s) or any other modified form of Deltamethrin. It belongs to the class of pyrethroid insecticide. It prevents the sodium channels from functioning, so that no transmission of nerve impulses can take place.

As used herein, the term “Lambda-Cyhalothrin” encompasses its agrochemically acceptable salt(s), derivative(s) or any other modified form of Lambda-Cyhalothrin. It belongs to the class of pyrethroid insecticide. It acts on the nervous system of insects and disturbs the function of neurons by interaction with the sodium channels.

The present invention provides a synergistic compositions comprising Chlorantraniliprole, Methoxyfenozide, at least one insecticidal compound selected from Deltamethrin or Lambda-Cyhalothrin and one or more excipients.

It has been surprisingly found that composition comprising Chlorantraniliprole, Methoxyfenozide and at least one insecticidal compound selected from Deltamethrin or Lambda-Cyhalothrin not only provides effective control of insect pests but also such combination is synergistic in nature.

In yet another embodiment, the composition according to the present invention comprises Chlorantraniliprole in an amount in the range from 1 to 30% w/w, Methoxyfenozide in an amount in the range from 1 to 30% w/w, Deltamethrin in an amount in the range from 1 to 10% w/w and one or more excipients. In a preferred embodiment, the synergistic insecticidal composition comprises of Chlorantraniliprole in an amount 6% w/w, Methoxyfenozide in an amount 21% w/w, Deltamethrin in an amount 1.25% w/w and one or more excipients.

In a further embodiment, the composition according to the present invention comprises Chlorantraniliprole in an amount in the range from 1 to 30% w/w, Methoxyfenozide in an amount in the range from 1 to 30% w/w, Lambda-Cyhalothrin in an amount in the range from 1 to 10% w/w and one or more excipients. In a preferred embodiment, the synergistic insecticidal composition comprises of Chlorantraniliprole in an amount 6% w/w, Methoxyfenozide in an amount 21% w/w, Lambda-Cyhalothrin in an amount of 1.5% w/w and one or more excipients.

In another embodiment, the composition of the present invention is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or a mixed formulation of CS and SE (ZE), a mixed formulation of CS and EW (ZW). The composition of the present invention is preferably formulated as SC and ZC.

In an aspect, the composition of the present invention comprises one or more excipients selected from surfactant/dispersing agent, wetting agent, emulsifier, anti-freeze agent, defoamer, biocide, thickener, solvent, capsule forming monomer I and II, disintegrating agent, pH adjuster, and/or stabilizer or a combination thereof.

It is generally observed that solid particles in a liquid undergo spontaneous aggregation to form lumps. Hence, it is recommended to add a dispersing agent/surfactant which prevents agglomeration of solid particles and keep them suspended in fluid. Accordingly, the composition of the present invention contains dispersing agent such as amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer (Ethylan™M NS-500LQ), ethoxylated polyarylphenol phosphate ester. One or more dispersing agents may be used in the synergistic composition of the present invention. The dispersing agent is present in an amount in the range from 2 to 10% w/w.

Wetting is the first stage of dispersion, in which air surrounding the granular composition is substituted with water. Wetting of the composition with water cannot occur if the surface tension of the liquid is very high. Hence, it is recommended to add a wetting agent to the composition to facilitate the process of dispersion of the granules in the liquid. Non-limiting examples of wetting agents that can be used in the present invention include, but not limited to, ethoxylated polyarylphenol phosphate ester, dioctyl sulphosuccinate, non-ionic ethoxylate. One or more wetting agents may be used in the synergistic composition of the present invention. The wetting agent is present in an amount in the range from 1 to 5% w/w.

An emulsifier is a kind of surfactant. It helps to prevent the droplets of the dispersed phase of an emulsion from flocculating or coalescing in the emulsion. It can be or include a cationic, zwitterionic or a non-ionic emulsifier. Suitable emulsifier used herein, but not limited to, tristyryl phenol, polyalkylene oxide block copolymer, high molecular weight polymer PEG-10 PPG-5 cetyl phosphate, non-ionic ethoxylated emulsifier, blend of nonionic-anionic emulsifiers (proprietary blend) or a combination thereof. Preferably, emulsifier is present in an amount in the range from 2 to 5% w/w.

An anti-freeze agent is generally added to the composition, to prevent the aqueous compositions from freezing. Suitable anti-freeze agents used herein, but not limited to, glycerine, propylene glycol, diethylene glycol, monoethylene glycol or a combination thereof and present in an amount in the range from 2 to 10% w/w.

A biocide is added to the composition of the present invention for its preservation against spoilage from bacteria, yeasts and fungi. Suitable biocide used herein, but not limited to, 20% aqueous dipropylene glycol solution of 1,2-benzisothiazolin-3-one, formaldehyde, isothiazolinone or a combination thereof, and present in an amount in the range from 0.01 to 0.50% w/w.

A defoamer is generally added to the composition, as foam formation prevents the efficient filling of a container. Suitable defoamer used herein, but not limited to, polysiloxane, polydimethyl siloxane, organic fluorine compounds or a combination thereof and present in an amount in the range from 0.01 to 0.5% w/w.

A thickener is added to the composition to reduce the tendency of the composition to disperse when sprayed, and decrease the likelihood of it being rinsed off from the crops. Suitable thickener used herein are water-soluble polymer and inorganic fine powder. The water-soluble polymer is selected from xanthan gum, welan gum, guar gum, polyvinyl alcohol, carboxymethylcellulose, polyvinylpyrrolidone, carboxyvinyl polymer, acrylic polymer, starch derivative or polysaccharide. The inorganic fine powder is selected from high purity silica, bentonite, white carbon or a combination thereof. The thickener is present in an amount in the range from 0.01 to 0.5% w/w. Xanthan gum used in the present invention is obtained from a commercial source.

The solvent used in the present invention is selected from the group comprising of water; alcohols such as ethanol, propanol, n-octanol, isopropanol ethylene glycol, diethylene glycol, propylene glycol, polyethylene glycol, glycerine; polyol ethers such as ethylene glycol monopropyl ether, diethylene glycol monomethyl ether, dipropylene glycol dimethyl ether; ketones such as acetone, methyl ethyl ketone, methyl isobutyl ketone, cyclohexanone; ethers such as dipropyl ether, dioxane, tetrahydrofuran; aliphatic hydrocarbons such as normal paraffin, isoparaffin, kerosene, mineral oil; aromatic hydrocarbons such as xylene, toluene, naphthalene, solvent naphtha, solvent C9, solvent C10, solvent C12, solvesso 100, solvesso 150, solvesso 200; chlorinated aliphatic or aromatic hydrocarbons such as chlorobenzene, chloroethylene, methylene chloride; esters such as ethyl acetate, diisopropyl phthalate, dimethyl adipate, methyl oleate, methyl tallowate; lactones such as gamma-butyrolactone; amides such as dimethylformamide, N-methyl-2-pyrrolidone, N-octylpyrolidone, N,N-dimethyldecanamide; nitriles such as acetonitrile; organosulfur compound such as dimethyl sulfoxide. The solvent may be used alone or in combination and is present in an amount 5 to 15% w/w.

The composition of the present invention also comprises capsule forming monomer I and II. The capsule forming monomer I is selected from polyisocyanate, toluene di-isocyante and tri-isocyanate present in an amount in the range from 0.5 to 3% w/w; and the capsule forming monomer II is selected from ethylenediamine, diethylenetetramine and hexaethylenediamine present in an amount in the range from 0.2 to 2% w/w.

Disintegrating agent is selected from the group comprising of sodium tripolyphosphate, stearic acid metal salt, cellulose powder, dextrin, methacrylate copolymer, polyvinylpyrrolidone, polyaminocarboxylic acid chelate compound, styrene sulfonate/isobutylene/maleic anhydride copolymer, starch/polyacrylonitrile graft copolymer, sodium hexametaphosphate, carboxymethyl cellulose, sodium polycarbonate, bentonite.

pH adjuster is selected from the group comprising of, sodium or potassium carbonate, sodium or potassium hydrogen carbonate, sodium or potassium dihydrogen phosphate, disodium or dipotassium hydrogen phosphate, citric acid, malic acid and triethanolamine.

Stabilizer is selected from the group comprising of drying agents such as zeolite, quicklime or magnesium oxide; antioxidant agents such as phenol type, amine type, sulfur type or phosphorus type; or ultraviolet absorbers such as salicylic acid type or a benzophenone type.

The composition of the present invention can be applied by any one of the methods selected from atomization, spreading, dusting, spraying, diffusion, immersion, irrigation, injection, mixing, sprinkling (water immersion), foaming, dressing, coating, blasting, fumigation, smoking, smog and painting.

In an embodiment, the present invention provides a process for the preparation of a SC formulation which comprises mixing of Chlorantraniliprole, Methoxyfenozide and one of Deltamethrin or Lambda-Cyhalothrin; and at least one excipient.

In another embodiment, the present invention provides a process for the preparation of a ZC composition. The process comprises: a) mixing Chlorantraniliprole, Methoxyfenozide, and at least one excipient to prepare a first composition b) mixing Deltamethrin or Lambda-Cyhalothrin, solvent and capsule forming monomer I to obtain an organic phase c) mixing water and at least one excipient to obtain an aqueous phase d) mixing of both the phases and capsule forming monomer II to obtain second composition e) final mixing of first composition and second composition to prepare a ZC formulation.

In an embodiment, the composition of the present invention is effective in the management of insect pests such as Spodoptera, borer, looper, sucking pests, moth, fly etc. in cereals, paddy, pulses, oilseeds, horticulture crops, pasture crops, fibre crops, sugar cane and spice crops.

The synergistic composition of the present invention provides a number of other advantages:
Increased efficacy in comparison to the other formulations tested during the trial.
Economically beneficial to the farmers as it provides better yield of the crop with reduction in the number of sprays.
Reduced possibility of hazards to the farmers due to occupational exposure because of reduction in the number of sprays.
Is storage stable.
Is non-phytotoxic.
Environmental friendly

The embodiments of the present invention are more particularly described in the following examples that are intended as illustrations only, since numerous modifications and variations within the scope of the present invention will be apparent to those of skill in the art. Unless otherwise noted, all parts, percentages and ratios reported in the following examples are on a weight basis and all excipients used in the examples were obtained or are available from the chemical suppliers.

### EXAMPLES

The synergistic insecticidal composition of the present invention comprising Chlorantraniliprole, Methoxyfenozide and one of Deltamethrin/Lambda-cyhalothrin in SC and ZC form is provided in example 1 to 10. The unit of each component of the composition are expressed in “ % w/w” i.e. the percentage by weight, relative to the weight of the total solution or composition.

### Examples 1 to 4

TABLE 1
Chlorantraniliprole, Methoxyfenozide and Deltamethrin SC

| Sr. | | Eg: 1 | Eg: 2 | Eg: 3 | Eg: 4 |
|---|---|---|---|---|---|
| No. | Ingredients | % w/w | % w/w | % w/w | % w/w |
| 1 | Chlorantraniliprole | 1 | 3 | 6 | 30 |
| | Technical (100% Basis) | | | | |
| 2 | Methoxyfenozide | 30 | 1 | 21 | 2 |
| | Technical (100% Basis) | | | | |
| 3 | Deltamethrin Technical | 1.25 | 10 | 1.25 | 1 |
| | (100% Basis) | | | | |
| 4 | Anti-freeze Agent | 5 | 7 | 5 | 5 |
| | (Propylene glycol) | | | | |
| 5 | Dispersing Agent | 6 | 5 | 5 | 5 |
| | (Graft Copolymer) | | | | |
| 6 | Wetting Agent | 4 | 4 | 3 | 3 |
| | (Non-ionic ethoxylate) | | | | |
| 7 | Defoamer (Dimethyl | 0.1 | 0.1 | 0.1 | 0.1 |
| | Polysiloxane emulsion) | | | | |
| 8 | Biocide (Proxel GXL) | 0.1 | 0.1 | 0.1 | 0.1 |
| 9 | Thickener (Xanthan Gum) | 0.2 | 0.2 | 0.2 | 0.2 |
| 10 | Demineralized water | Q.S. to | Q.S. to | Q.S. to | Q.S. to |
| | | make 100 | make 100 | make 100 | make 100 |

QS: quantity sufficient required to make 100% w/w formulation

### Examples 5 to 8

TABLE 2
Chlorantraniliprole, Methoxyfenozide and Lambda-cyhalothrin SC

| Sr. | | Eg: 5 | Eg: 6 | Eg: 7 | Eg: 8 |
|---|---|---|---|---|---|
| No. | Ingredients | % w/w | % w/w | % w/w | % w/w |
| 1 | Chlorantraniliprole | 1 | 3 | 6 | 30 |
| | Technical (100% Basis) | | | | |
| 2 | Methoxyfenozide | 5 | 30 | 21 | 1 |
| | Technical (100% Basis) | | | | |
| 3 | Lambda-cyhalothrin | 10 | 4 | 1.5 | 1 |
| | Technical (100% Basis) | | | | |
| 4 | Anti-freeze Agent | 7 | 5 | 5 | 5 |
| | Propylene glycol) | | | | |
| 5 | Dispersing Agent | 5 | 6 | 5 | 5 |
| | (Graft Copolymer) | | | | |
| 6 | Wetting Agent | 4 | 4 | 3 | 3 |
| | (Non-ionic ethoxylate) | | | | |
| 7 | Defoamer (Dimethyl | 0.1 | 0.1 | 0.1 | 0.1 |
| | Polysiloxane emulsion) | | | | |
| 8 | Biocide (Proxel GXL) | 0.1 | 0.1 | 0.1 | 0.1 |
| 9 | Thickener (Xanthan Gum) | 0.2 | 0.2 | 0.2 | 0.2 |
| 10 | Demineralized water | Q.S. to | Q.S. to | Q.S. to | Q.S. to |
| | | make 100 | make 100 | make 100 | make 100 |

QS: quantity sufficient required to make 100% w/w formulation

### Process of Preparing Synergistic Insecticidal Composition Comprising Methoxyfenozide, Chlorantraniliprole and Deltamethrin/Lambda-cyhalothrin SC

Table 3 provides quantities of active ingredients and raw material charged to prepare the synergistic composition of the present invention in SC form. In table 3, active ingredients Methoxyfenozide, Chlorantraniliprole, Deltamethrin, Lambda-cyhalothrin are in technical grade with 95%, 95%, 90% and 95% purity respectively. Particularly, example 3 and 7 corresponds to column A and B in table 3.

TABLE 3
Quantities of active ingredients and raw material charged

| | | | A | B |
|---|---|---|---|---|
| Sr. | | | Quantity | Quantity |
| No. | Ingredients | Function | (g) | (g) |
| 1 | Chlorantraniliprole | Active ingredient | 6.31 | 6.31 |
| | Technical (Basis of 95.0%) | | | |
| 2 | Methoxyfenozide | Active ingredient | 22.20 | 22.20 |
| | Technical (Basis of 95.0%) | | | |
| 3 | Deltamethrin | Active ingredient | 1.39 | — |
| | Technical (Basis of 90.0%) | | | |
| 4 | Lambda-cyhalothrin | Active ingredient | — | 1.58 |
| | (Basis of 95.0%) | | | |
| 5 | Propylene glycol | Anti-freeze Agent | 05.00 | 05.00 |
| 6 | Graft Copolymer | Dispersing Agent | 05.00 | 05.00 |
| 7 | Non-ionic ethoxylate | Wetting Agent | 03.00 | 03.00 |
| 8 | Dimethyl Polysiloxane emulsion | Defoamer | 00.10 | 00.10 |
| 9 | Proxel GXL | Biocide | 00.10 | 00.10 |
| 10 | Xanthan Gum | Thickener | 00.20 | 00.20 |
| 11 | Demineralized water | Solvent | 56.70 | 56.51 |
| | Total | | 100.00 | 100.00 |

The ingredients were weighed and taken as per Table 3. Demineralised water, Proxel GXL (0.10 g) and dimethyl Polysiloxane emulsion (0.10 g) were taken. Then, propylene glycol (5 g), graft Copolymer (5 g), Non-ionic ethoxylate (3 g) were added and stirred well. To the mixture, Chlorantraniliprole (6.31 g), Methoxyfenozide (22.2 g) and one of Deltamethrin (1.39 g) or Lamba-cyhalothrin (1.58 g) were added with stirring. The mixture was homogenized with high speed homogenizer to obtain homogeneous slurry. The slurry was wet grinded using a suitable bead mill till required particle size was achieved. During wet grinding temperature was maintained between 25° C. to 30° C. After wet grinding, material was withdrawn through mill and water wash was given with remaining water and was withdrawn in the same container and mixed well. To the material water solution of thickener was added under low stirring to obtain the title insecticidal composition in SC form.

### Example 9

TABLE 4
Chlorantraniliprole, Methoxyfenozide and Deltamethrin ZC

| Sr. | | Quantity |
|---|---|---|
| No. | Ingredients | (% By Weight) |
| 1 | Chlorantraniliprole Technical (Basis of 100.0%) | 6.00 |
| 2 | Methoxyfenozide Technical (Basis of 100.0%) | 21.00 |
| 3 | Deltamethrin Technical (Basis of 100.0%) | 1.25 |
| 4 | Anti-freeze Agent (Propylene glycol/DEG/MEG) | 2-10 |
| 5 | Dispersing Agent (Amine salt of phosphate tristyryl | 2-10 |
| | phenol ethoxylated/Acrylic Copolymer/Graft copolymer) | |
| 6 | Wetting Agent (Ethoxylated Polyarylphenol Phosphate | 1-5 |
| | Ester/Dioctyl sulphosuccinate/Non-ionic ethoxylate) | |
| 7 | Capsule forming Monomer I (Polyisocyanate/Toluene | 0.5-3.00 |
| | Diisocyante/Tri-isocyanate) | |
| 8 | Capsule forming Monomer II (Ethylenediamine/ | 0.2-2.00 |
| | Diethylenetetramine/hexaethylene diamine) | |
| 9 | Solvent (Naphtha, Xylene, Decanamide, solvent C-IX) | 05.-15.00 |
| 10 | Emulsifier (Non-ionic ethoxylated emulsifier, Blend | 02-05.00 |
| | of nonionic - anionic emulsifiers (proprietary blend) | |
| 11 | Defoamer (Dimethyl Polysiloxane emulsion) | 00.01-00.50 |
| 12 | Biocide (Proxel GXL/Formaldehyde) | 00.01-00.50 |
| 13 | Thickener (Xanthan Gum) | 00.01-00.50 |
| 14 | Demineralized water | Q.S. to make 100 |
| | Total | 100.00 |

Q.S.: quantity sufficient required to make 100% w/w formulation

### Process for the preparation of Chlorantraniliprole, Methoxyfenozide and Deltamethrin ZC

### Step—1 Process for the Preparation of SC Formulation Comprising Chlorantraniliprole and Methoxyfenozide

TABLE 5

| Sr. | | Quantity |
|---|---|---|
| No. | Ingredients | (g) |
| 1 | Chlorantraniliprole Technical (Basis of 95.0%) | 6.31 |
| 2 | Methoxyfenozide Technical (Basis of 95.0%) | 22.20 |
| 3 | Anti-freeze Agent (Propylene glycol) | 5.00 |
| 4 | Dispersing Agent (Graft Copolymer) | 5.00 |
| 5 | Wetting Agent (Non-ionic ethoxylate) | 3.00 |
| 6 | Defoamer (Dimethyl Polysiloxane emulsion) | 00.10 |
| 7 | Biocide (Proxel GXL) | 00.10 |
| 8 | Thickener (Xanthan Gum) | 00.20 |
| 9 | Demineralized water | 58.09 |
| 10 | Total | 100.00 |

Demineralised water, Proxel GXL (0.10 g) and Dimethyl Polysiloxane emulsion (0.10 g) were taken. Then, propylene glycol (5 g), Graft Copolymer (5 g), Non-ionic ethoxylate (3 g) were added and stirred well. To the mixture, chlorantraniliprole (6.31 g), methoxyfenozide (22.2 g) were added with stirring. The mixture was homogenized with high speed homogenizer to obtain homogeneous slurry. The slurry was wet grinded using a suitable bead mill till required particle size was achieved. During wet grinding temperature was maintained between 25° C. to 30° C. After wet grinding, material was withdrawn through mill and water wash was given with remaining water and was withdrawn in the same container and mixed well. To the material was added water solution of thickener under low stirring to obtain the composition comprising chlorantraniliprole and methoxyfenozide in SC form.

### Step—2 Process for the Preparation of CS Formulation Comprising Deltamethrin

The preparation of CS formulation involves two phases: organic and aqueous phase. All the ingredients were weighed and taken as per the below Table 6.

TABLE 6

| Sr. | | Quantity |
|---|---|---|
| No. | Ingredients | (g) |
| 1 | Deltamethrin Technical (Basis of 95.0%) | 1.39 |
| 2 | Capsule forming Monomer I (Diphenylmethane diisocyanate)) | 3.00 |
| 3 | Capsule forming Monomer II (Diethylenetetramine) | 1.00 |
| 4 | Solvent (solvent C-IX) | 5.00 |
| 5 | Emulsifier (Non-ionic ethoxylate emulsifier) | 5.00 |
| 6 | Defoamer (Dimethyl Polysiloxane emulsion) | 0.20 |
| 7 | Demineralized water | 84.41 |
| 8 | Total | 100 |

1. Organic phase: Solvent C-IX was taken and Deltamethrin was added and dissolved to obtain a clear solution. Diphenylmethane diisocyanate was then added and stirred well to obtain a homogenous mixture.
2. Aqueous Phase: Water, Dimethyl Polysiloxane emulsion, non-ionic ethoxylate emulsifier were taken and mixed well to obtain aqueous phase.
3. The organic phase prepared above was slowly added into aqueous phase with continuous stirring. Both phases were mixed using high speed homogeniser at 2000-2500 rpm to obtain a fine emulsion droplet size. Emulsion droplet size was monitored during process until particle size D-90<50 micron was achieved. The mixture was transferred to two neck round bottomed flask and kept in a water bath at 50° C. with stirrer and thermometer pocket. The mixture was stirred for 1 hour, then Diethylenetetramine was added and was continuously mixed at 500 -1000 rpm for 2 hours to get uniform CS formulation.

### Step 3:

The CS formulation obtained in step 2 was cooled then mixed with SC formulation obtained in step 1 to obtain ZC formulation comprising Chlorantraniliprole, Methoxyfenozide and Deltamethrin.

### Example 10

TABLE 7
Chlorantraniliprole, Methoxyfenozide and Lambda-cyhalothrin ZC

| Sr. | | Quantity |
|---|---|---|
| No. | Ingredients | (% By Weight) |
| 1 | Methoxyfenozide Technical (Basis of 100.0%) | 21.00 |
| 2 | Chlorantraniliprole Technical (Basis of 100.0%) | 6.00 |
| 3 | Lambda-Cyhalothrin Technical (Basis of 100.0%) | 1.5 |
| 4 | Anti-freeze Agent (Propylene glycol/DEG/MEG) | 2-10 |
| 5 | Dispersing Agent (Amine salt of phosphate tristyryl | 2-10 |
| | phenol ethoxylated/Acrylic Copolymer/Graft copolymer) | |
| 6 | Wetting Agent (Ethoxylated Polyarylphenol Phosphate | 1-5 |
| | Ester/Dioctyl sulphosuccinate/Non-ionic ethoxylate) | |
| 7 | Capsule forming Monomer I (Polyisocyanate/Toluene | 0.5-3.00 |
| | Diisocyante/Tri-isocyanate) | |
| 8 | Capsule forming Monomer II (Ethylenediamine/ | 0.2-2.00 |
| | Diethylenetetramine/hexaethylenediamine) | |
| 9 | Solvent (Naphtha, Xylene, Decanamide, solvent C-IX) | 05-15.00 |
| 10 | Emulsifier (Non-ionic ethoxylated emulsifier, Blend | 02-05.00 |
| | of nonionic - anionic emulsifiers (proprietary blend) | |
| 11 | Defoamer (Dimethyl Polysiloxane emulsion) | 00.01-00.50 |
| 12 | Biocide (Proxel GXL/Formaldehyde) | 00.01-00.50 |
| 13 | Thickener (Xanthan Gum) | 00.01-00.50 |
| 14 | Demineralized Water | Q.S. to make 100 |
| | Total | 100.00 |

Q.S.: quantity sufficient required to make 100% w/w formulation

### Process for the Preparation of Chlorantraniliprole, Methoxyfenozide and Lambda-cyhalothrin ZC

Step—1 Process for the Preparation of SC Formulation Comprising Chlorantraniliprole and Methoxyfenozide is Same as Given in step-1 of Example 9.

### Step—2 Process for the preparation of CS formulation comprising lambda-cyhalothrin

The preparation of CS formulation involves two phases: organic and aqueous phase. All the ingredients were weighed and taken as per the below Table 8.

TABLE 8

| Sr. | | Quantity |
|---|---|---|
| No. | Ingredients | (g) |
| 1 | Lambda-cyhalothrin Technical | 1.58 |
| | (Basis of 95.0%) | |
| 2 | Capsule forming Monomer I | 3.00 |
| | (Diphenylmethane diisocyanate) | |
| 3 | Capsule forming Monomer II | 1.00 |
| | (Diethylenetetramine) | |
| 4 | Solvent (solvent C-IX) | 5.00 |
| 5 | Emulsifier (Non-ionic | 5.00 |
| | ethoxylate emulsifier) | |
| 6 | Defoamer (Dimethyl | 0.20 |
| | Polysiloxane emulsion) | |
| 7 | Demineralized water | 84.22 |
| | Total | 100.00 |

1. Organic phase: Solvent C-IX and Lambda-cyhalothrin was added and dissolved to obtain a clear solution. Diphenylmethane diisocyanate was then added and stirred well to obtain a homogenous mixture.
2. Aqueous Phase: Water, Dimethyl Polysiloxane emulsion, Non-ionic ethoxylate emulsifier were taken and mixed well to obtain aqueous phase.
3. The organic phase prepared above was slowly added into aqueous phase with continuous stirring. Both phases were mixed using high speed homogeniser at 2000-2500 rpm to obtain a fine emulsion droplet size. Emulsion droplet size was monitored during process until particle size D-90<50 micron was achieved. The mixture was transferred to two neck round bottomed flask and kept in a water bath at 50° C. with stirrer and thermometer pocket. The mixture was stirred for 1 hour, then Diethylenetetramine was added and was continuously mixed at 500 -1000 rpm for 2 hours to get uniform CS formulation.
   Step 3: The CS Formulation Obtained in Step 2 was Cooled then Mixed with SC Formulation Obtained in Step 1 to Obtain ZC Formulation Comprising Chlorantraniliprole, Methoxyfenozide and Lambda-cyhalothrin.

### Bio-Efficacy of the Insecticidal Composition of the Present Invention

### Details of the Experiment

A field trial was conducted on sugarcane crop (Variety: CoLK 94184) to evaluate the control of early shoot borer with solo formulations, binary formulations and ternary composition of the present invention as per details provided in Table 9 and Table 10.

The experiment was laid out in Randomized Block Design (RBD). The plot size was 10 m×10 m and the spacing was 90 cm×45 cm. All the recommended agronomic practices were followed throughout the cropping period. Applications were made with a domestic sprayer fitted with a pressure regulator and hollow cone nozzle. One single application was made using hollow cone nozzle using spray fluid 500 l/ha at an interval of 60 days after planting. The various treatments were sprayed on sugarcane crop to evaluate the control of early shoot borer. All treatments were replicated thrice. Based on various doses, weighed quantity of test products were dissolved in 5 litres of water/treatment and sprayed uniformly.

Observations were made at 5, 10, 15 and 30 days after application. The number of dead-hearts per plot were recorded on suitable number of randomly selected plants per replication.

Pest incidence and pest intensity were calculated using following formulae:

Percent Borer incidence=No. of dead hearts per hill×100/Total No. of tillers per hill

The final Sugarcane yield (qt/ha) was recorded after harvest of crop.

TABLE 9
Efficacy data of Chlorantraniliprole 6% + Methoxyfenozide 21% + Deltamethrin 1.25% ZC/SC

| | | | | Early Shoot Borer | | | | | % | |
|---|---|---|---|---|---|---|---|---|---|---|
| | | Dose | Dose | incidence (% Dead heart) | | | | | reduction | |
| S. | | Formulation | a.i./ha | 5 | 10 | 15 | 30 | | against | Yield |
| No. | Treatment | (g/ml/ha) | (g) | DAA | DAA | DAA | DAA | Mean | control | (qt/ha) |
| 1 | Chlorantraniliprole | 500 ml | 30 + | 4.00 | 3.00 | 2.67 | 2.67 | 3.09 | 84.04 | 671.0 |
| | 6% + Methoxyfenozide | | 105 + | (11.54) | (9.97) | (9.40) | (9.40) | (10.12) | | |
| | 21% + Deltamethrin | | 6.25 | | | | | | | |
| | 1.25% ZC | | | | | | | | | |
| 2 | Chlorantraniliprole | 500 ml | 30 + | 3.67 | 2.67 | 2.33 | 2.33 | 2.75 | 85.78 | 685.3 |
| | 6% + Methoxyfenozide | | 105 + | (11.04) | (9.40) | (8.78) | (8.78) | (9.55) | | |
| | 21% + Deltamethrin | | 6.25 | | | | | | | |
| | 1.25% SC | | | | | | | | | |
| 3 | Methoxyfenozide | 437.5 + | 30 + | 7.33 | 6.67 | 6.33 | 7.00 | 6.83 | 64.66 | 591.0 |
| | 21.8% w/w SC + | 150 | 105 | (15.71) | (14.97) | (14.57) | (15.34) | (15.15) | | |
| | Chlorantraniliprole | | | | | | | | | |
| | 18.5% SC | | | | | | | | | |
| 4 | Methoxyfenozide | 437.5 + | 105 + | 8.67 | 8.00 | 8.33 | 9.67 | 8.67 | 55.17 | 562.1 |
| | 21.8% w/w SC + | 150 | 7.5 | (17.12) | (16.43) | (16.78) | (18.12) | (17.12) | | |
| | Deltamethrin | | | | | | | | | |
| | 02.80% EC | | | | | | | | | |
| 5 | Chlorantraniliprole | 150 + | 30 + | 7.00 | 6.00 | 6.67 | 8.67 | 7.09 | 63.35 | 599.0 |
| | 18.5% SC + | 150 | 7.5 | (15.34) | (14.18) | (14.97) | (17.12) | (15.44) | | |
| | Deltamethrin | | | | | | | | | |
| | 02.80% EC | | | | | | | | | |
| 6 | Methoxyfenozide | 437.5 | 105 | 12.33 | 11.67 | 11.33 | 10.67 | 11.50 | 40.51 | 513.6 |
| | 21.8% w/w SC | | | (20.56) | (19.98) | (19.67) | (19.07) | (19.82) | | |
| 7 | Chlorantraniliprole | 150 | 30 | 7.67 | 8.00 | 10.00 | 11.67 | 9.34 | 51.71 | 546.2 |
| | 18.5% SC | | | (16.08) | (16.43) | (18.43) | (19.98) | (17.79) | | |
| 8 | Deltamethrin | 250 | 6.25 | 10.33 | 12.67 | 14.00 | 15.33 | 13.08 | 32.33 | 504.7 |
| | 02.80% EC | | | (18.75) | (20.85) | (21.97) | (23.05) | (21.20) | | |
| 9 | Control | — | — | 15.33 | 18.67 | 20.33 | 23.00 | 19.33 | — | 407.6 |
| | | | | (23.05) | (25.60) | (26.80) | (28.66) | (26.08) | | |
| | SEm± | — | — | 0.286 | 0.387 | 0.433 | 0.486 | 0.393 | — | 3.892 |
| | CD 5% | — | — | 0.866 | 1.170 | 1.310 | 1.470 | 1.190 | — | 12.319 |

Figure in parenthesis represents arc sin transformed value;
SEm±: Standard errors of means;
CD@5%: Critical Difference

TABLE 10
Efficacy data of Chlorantraniliprole 6% + Methoxyfenozide 21% + Lambda-Cyhalothrin 1.5% ZC/SC

| | | | | Early Shoot Borer | | | | | % | |
|---|---|---|---|---|---|---|---|---|---|---|
| | | Dose | Dose | incidence (% Dead heart) | | | | | reduction | |
| S. | | Formulation | a.i./ha | 5 | 10 | 15 | 30 | | against | Yield |
| No. | Treatment | (g/ml/ha) | (g) | DAA | DAA | DAA | DAA | Mean | control | (q/ha) |
| 1 | Chlorantraniliprole | 500 ml | 30 + | 3.67 | 2.33 | 2.00 | 2.33 | 2.58 | 86.64 | 678.2 |
| | 6% + Methoxyfenozide | | 105 + | (11.04) | (8.78) | (8.13) | (8.78) | (9.25) | | |
| | 21% + Lambda- | | 7.5 | | | | | | | |
| | Cyhalothrin 1.5% ZC | | | | | | | | | |
| 2 | Chlorantraniliprole | 500 ml | 30 + | 3.33 | 2.00 | 2.00 | 2.33 | 2.42 | 87.51 | 689.0 |
| | 6% + Methoxyfenozide | | 105 + | (10.51) | (8.13) | (8.13) | (8.78) | (8.94) | | |
| | 21% + Lambda- | | 7.5 | | | | | | | |
| | Cyhalothrin 1.5% SC | | | | | | | | | |
| 3 | Methoxyfenozide | 437.5 + | 30 + | 7.33 | 6.67 | 6.33 | 7.00 | 6.83 | 64.66 | 591.0 |
| | 21.8% w/w SC + | 150 | 105 | (15.71) | (14.97) | (14.57) | (15.34) | (15.15) | | |
| | Chlorantraniliprole | | | | | | | | | |
| | 18.5% SC | | | | | | | | | |
| 4 | Methoxyfenozide | 437.5 + | 105 + | 8.00 | 7.33 | 7.67 | 8.67 | 7.92 | 59.05 | 570.6 |
| | 21.8% w/w SC + | 150 | 7.5 | (16.43) | (15.71) | (16.08) | (17.12) | (16.34) | | |
| | Lambda cyhalothrin | | | | | | | | | |
| | 5% EC | | | | | | | | | |
| 5 | Chlorantraniliprole | 150 + | 30 + | 6.33 | 5.67 | 6.67 | 8.00 | 6.67 | 65.51 | 603.2 |
| | 18.5% SC + Lambda | 150 | 7.5 | (14.57) | (13.78) | (14.97) | (16.43) | (14.96) | | |
| | cyhalothrin 5% EC | | | | | | | | | |
| 6 | Methoxyfenozide | 437.5 | 105 | 12.33 | 11.67 | 11.33 | 10.67 | 11.50 | 40.51 | 513.6 |
| | 21.8% w/w SC | | | (20.56) | (19.98) | (19.67) | (19.07) | (19.82) | | |
| 7 | Chlorantraniliprole | 150 | 30 | 7.67 | 8.00 | 10.00 | 11.67 | 9.34 | 51.71 | 546.2 |
| | 18.5% SC | | | (16.08) | (16.43) | (18.43) | (19.98) | (17.79) | | |
| 8 | Lambda cyhalothrin | 150 | 7.5 | 9.00 | 12.33 | 14.67 | 17.00 | 13.25 | 31.46 | 501.3 |
| | 5% EC | | | (17.46) | (20.56) | (22.52) | (24.35) | (21.35) | | |
| 9 | Control | — | — | 15.33 | 18.67 | 20.33 | 23.00 | 19.33 | — | 407.6 |
| | | | | (23.05) | (25.60) | (26.80) | (28.66) | (26.08) | | |
| | SEm | — | — | 0.292 | 0.402 | 0.451 | 0.508 | 0.407 | — | 3.892 |
| | CD 5% | — | — | 0.884 | 1.214 | 1.364 | 1.535 | 1.230 | — | 12.319 |

Figure in parenthesis represents arc sin transformed value;
SEm±: Standard errors of means;
CD@5%: Critical Difference

It is evident from the above tables that the insecticidal composition of the present invention gave good control of insects and higher yield as compared to the reference products (solo or binary composition).

### Evaluation of Synergistic Effect

A synergistic effect exists whenever the action of an active ingredient combination is greater than the sum of the actions of the individual components. Synergism was calculated by using Colby's method, Weeds, vol. 15 No. 1(January 1967), pp. 20-2.

The synergistic action expected for a given combination of three active components can be calculated as follows:

$$E = ( X + Y + Z ) - \frac{( X Y + Y Z + X Z )}{100} + \frac{X Y Z}{10000}$$

Where:

E represents expected percentage of control for the combination of the three active ingredients at defined doses (for example equal to x, y and z respectively),

X is the percentage of control observed by the compound (I) at a defined dose (equal to x),

Y is the percentage of control observed by the compound (II) at a defined dose (equal to y),

Z is the percentage of control observed by the compound (III) at a defined dose (equal to z).

If observed control of the combination>Expected control, the combination is synergistic

If observed control of the combination<Expected control, the combination is antagonistic

If observed control of the combination=Expected control, the combination is additive

TABLE 11
Synergistic effect of Chlorantraniliprole 6% + Methoxyfenozide
21% + Deltamethrin 1.25% ZC /SC

| | | | | | % reduction |
|---|---|---|---|---|---|
| | | | | | expected |
| | | Dose | Dose | % reduction | (using |
| S. | | Formulation | a.i./ha | against | Colby's |
| No. | Treatment | (g/ml/ha) | (g) | control | formula) |
| 1 | Chlorantraniliprole 6% + | 500 ml | 30 + | 84.04 | 80.56 |
| | Methoxyfenozide 21% + | | 105 + 6.25 | | |
| | Deltamethrin 1.25% ZC | | | | |
| 2 | Chlorantraniliprole 6% + | 500 ml | 30 + | 85.78 | 80.56 |
| | Methoxyfenozide 21% + | | 105 + 7.5 | | |
| | Deltamethrin 1.25% SC | | | | |
| 3 | Methoxyfenozide 21.8% w/w SC | 437.5 | 105 | 40.51 | |
| 4 | Chlorantraniliprole 18.5% SC | 150 | 30 | 51.71 | |
| 5 | Deltamethrin 2.80% EC | 250 | 6.25 | 32.33 | |

TABLE 12
Synergistic effect of Chlorantraniliprole 6% + Methoxyfenozide
21% + Lambda-Cyhalothrin 1.5% ZC/SC

| | | | | | % reduction |
|---|---|---|---|---|---|
| | | | | % reduction | expected |
| | | Dose | Dose | against | (using |
| S. | | Formulation | a.i./ha | control | Colby's |
| No. | Treatment | (g/ml/ha) | (g) | (observed) | formula) |
| 1 | Chlorantraniliprole 6% + | 500 ml | 30 + | 86.64 | 80.31 |
| | Methoxyfenozide 21% + | | 105 + 7.5 | | |
| | Lambda-Cyhalothrin 1.5% ZC | | | | |
| 2 | Chlorantraniliprole 6% + | 500 ml | 30 + | 87.51 | 80.31 |
| | Methoxyfenozide 21% + | | 105 + 7.5 | | |
| | Lambda-Cyhalothrin 1.5% SC | | | | |
| 3 | Methoxyfenozide 21.8% w/w SC | 437.5 | 105 | 40.51 | |
| 4 | Chlorantraniliprole 18.5% SC | 150 | 30 | 51.71 | |
| 5 | Lambda-cyhalothrin 5% EC | 150 | 7.5 | 31.46 | |

It is evident from table 11 to 12 that the observed control is more than the expected control, hence, the composition of present invention is synergistic.

### Phytotoxicity Observations

For phytotoxicity evaluation on sugarcane crop, following observations were made by observing temporary or long lasting damage to the leaves if any viz., leaf injury on tips and leaf surface, wilting, vein clearing, necrosis, epinasty and hyponasty at 5, 10, 15, 30 days after application. Crop injury was observed on visual rating from 0-10 scale as given in Table 13 and Table 14 provides treatment details and phytotoxic effect of the synergistic composition of the present invention on sugarcane crop.

TABLE 13

| SCORE | PHYTOTOXICITY (PERCENT) |
|---|---|
| 0 | No phytotoxicity |
| 1 | 1-10 |
| 2 | 11-20 |
| 3 | 21-30 |
| 4 | 31-40 |
| 5 | 41-50 |
| 6 | 51-60 |
| 7 | 61-70 |
| 8 | 71-80 |
| 9 & 10 | Complete destruction |

TABLE 14
Phytotoxic effect of the composition of the present invention

| S. | | | | | | Vein | |
|---|---|---|---|---|---|---|---|
| No. | Treatments | Dose/ha | Epinasty | Hyponasty | Necrosis | clearing | Wilting |
| 1 | Chlorantraniliprole | 500 ml | 0 | 0 | 0 | 0 | 0 |
| | 6% + Methoxyfenozide | | | | | | |
| | 21% + Lambda- | | | | | | |
| | Cyhalothrin 1.5% ZC | | | | | | |
| 2 | Chlorantraniliprole | 500 ml | 0 | 0 | 0 | 0 | 0 |
| | 6% + Methoxyfenozide | | | | | | |
| | 21% + Lambda- | | | | | | |
| | Cyhalothrin 1.5% SC | | | | | | |
| 3 | Chlorantraniliprole | 500 ml | 0 | 0 | 0 | 0 | 0 |
| | 6% + Methoxyfenozide | | | | | | |
| | 21% + Deltamethrin | | | | | | |
| | 1.25% ZC | | | | | | |
| 4 | Chlorantraniliprole | 500 ml | 0 | 0 | 0 | 0 | 0 |
| | 6% + Methoxyfenozide | | | | | | |
| | 21% + Deltamethrin | | | | | | |
| | 1.25% SC | | | | | | |
| 5 | Control | — | 0 | 0 | 0 | 0 | 0 |

From the foregoing it will be observed that numerous modifications and variations can be effectuated without departing from the true spirit and scope of the novel concepts of the present invention. It is to be understood that no limitations with respect to the specific embodiments illustrated is intended or should be inferred. It should be understood that all such modifications and improvements have been deleted herein for the sake of conciseness and readability but are properly within the scope of the following claims.

We claim:

1. A synergistic insecticidal composition comprising:
a. Chlorantraniliprole;
b. Methoxyfenozide;
c. at least one compound selected from Deltamethrin and Lambda-Cyhalothrin; and
d. one or more excipients

2. The composition as claimed in claim 1, comprising:
a. Chlorantraniliprole in the range of 1 to 30% w/w;
b. Methoxyfenozide in the range of 1 to 30% w/w;
c. at least one compound selected from Deltamethrin and Lambda-Cyhalothrin in the range from 1 to 10% w/w; and
d. one or more excipients

3. The composition as claimed in claim 1, wherein the composition is selected from a group comprising:
Chlorantraniliprole present in an amount 6% w/w, Methoxyfenozide present in an amount 21% w/w; Deltamethrin present in an amount 1.25% w/w; and one or more excipients.
Chlorantraniliprole present in an amount 6% w/w, Methoxyfenozide present in an amount 21% w/w; Lambda-Cyhalothrin present in an amount of 1.5% w/w; and one or more excipients.

4. The composition as claimed in claim 1, wherein the composition is formulated as Capsule suspension (CS), Dispersible concentrate (DC), Dustable powder (DP), Powder for dry seed treatment (DS), Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable concentrate for seed treatment (FS), Granules (GR), Micro-emulsion (ME), Oil-dispersion (OD), Oil miscible flowable concentrate (OF), Oil miscible liquid (OL), Oil dispersible powder (OP), Suspension concentrate (SC), Suspension concentrate for direct application (SD), Suspo-emulsion (SE), Water soluble granule (SG), Soluble concentrate (SL), Spreading oil (SO), Water soluble powder (SP), Water soluble tablet (ST), Ultra-low volume (ULV) suspension, Tablet (TB), Ultra-low volume (ULV) liquid, Water dispersible granules (WG), Wettable powder (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW), preferably SC and ZC.

5. The composition as claimed in claims 1 and 4, wherein the composition is formulated as SC and ZC.

6. The composition as claimed in claim 1, wherein the excipient is selected from the group comprising of:
dispersing agent present in an amount in the range from 2 to 10% w/w;
wetting agent present in an amount in the range from 1 to 5% w/w;
emulsifier present in an amount in the range from 2 to 5% w/w;
anti-freeze agent present in an amount in the range from 2 to 10% w/w;
defoamer present in an amount in the range from 0.01 to 0.5% w/w;
biocide present in an amount in the range from 0.01 to 0.5% w/w;
thickener present in an amount in the range from 0.01 to 0.5% w/w;
solvent present in an amount in the range from 5 to 15% w/w; and
capsule forming monomer I and II present in an amount in the range from 0.2 to 3% w/w.

7. The composition as claimed in claim 6, wherein:
the dispersing agent is selected from the group comprising amine salt of phosphate tristyryl phenol ethoxylated, acrylic copolymer, graft copolymer, salt of naphthalene sulphonate, naphthalene sulfonate formaldehyde condensate, phosphate ester, salt of polycarboxylate, alcohol block copolymer, ethoxylated polyarylphenol phosphate ester or a combination thereof;
the wetting agent is selected from the group comprising ethoxylated polyarylphenol phosphate ester, dioctyl sulphosuccinate, non-ionic ethoxylate or a combination thereof;
the emulsifier is selected from the group comprising tristyryl phenol, polyalkylene oxide block copolymer, high molecular weight polymer PEG-10 PPG-5 cetyl phosphate, ethylene oxide (EO)-polyethylene oxide (PO) block copolymer or a combination thereof;
the anti-freeze agent is selected from the group comprising propylene glycol, diethylene glycol, monoethylene glycol or a combination thereof;
the defoamer is selected from the group comprising dimethyl polysiloxane emulsion, polysiloxane emulsion or a combination thereof;
the biocide is selected from the group comprising 20% aqueous dipropylene glycol solution of 1,2-benzisothiazolin-3-one, formaldehyde, isothiazolinone or a combination thereof;
the thickener is xanthan gum;
the solvent is selected from the group comprising naphtha, butan-1-ol, xylene, decanamide, N-methyl-2-pyrrolidone, dimethyl sulfoxide, C9, water or a combination thereof.

8. The composition as claimed in claim 6, wherein
a) the capsule forming monomer I is selected from polyisocyanate, toluene di-isocyante and tri-isocyanate present in an amount in the range from 0.5 to 3% w/w; and
b) the capsule forming monomer II is selected from ethylenediamine, diethylenetetramine and hexaethylenediamine present in an amount in the range from 0.2 to 2% w/w.
